(19) United States
(12) Patent Application Publication
(10) Pub. No.: US 2026/0312445 A1
(43) Pub. Date: Oct. 8, 2026

(54) ROTOR CORE, ROTOR, AND ELECTRIC MOTOR

(71) Applicant: FANUC CORPORATION, Yamanashi (JP)

(72) Inventor: Ryuya Yasuda

(21) Appl. No.: 19/482,432

(22) PCT Filed: Jun. 28, 2023
(86) PCT No.: PCT/JP2023/023944

§ 371 Date: Nov. 7, 2025

(51) Int. Cl. H02K 1/276

(52) U.S. Cl. CPC H02K 1/276

(57) ABSTRACT

Multiple pairs of magnet slots and a plurality of first holes are formed in a rotor core according to the present invention. Each of the multiple pairs of magnet slots includes a first magnet slot and a second magnet slot. The first holes include a first portion corresponding to at least a portion of the area between the radially inner end of the first magnet slot and the radially inner end of the second magnet slot, and a second portion which is continuous with the first portion and which is located farther inward than the first portion in the radial direction of the rotor core.

### CROSS-REFERENCE TO RELATED APPLICATIONS

This application is a National Stage application of International Application No. PCT/JP2023/023944 filed Jun. 28, 2023.

### FIELD

The present disclosure relates to a rotor core, a rotor, and an electric motor.

### BACKGROUND

A plurality of pairs of magnet slots which are arranged in a V-shape are formed in the end surface of a rotor core of a motor, and a magnet is inserted into each magnet slot. Holes are formed in the rotor core to reduce the weight and inertia of the rotor core (refer to, for example, Japanese Patent No. 6987310). However, if holes are formed inside each pair of magnet slots arranged in a V-shape, the flow of magnetic flux is obstructed, reducing torque.

In order to increase torque, extending the V-shaped tip of each pair of magnet slots radially inward of the rotor core has been considered. However, this would reduce the area of the rotor core where holes can be formed. As a result, it would be difficult to reduce the weight and inertia of the rotor. Furthermore, in this case, even if the rotor is inserted into the inner cylinder of a magnetizing yoke, it would be difficult to fully magnetize even a portion of the magnets positioned radially inward, which would result in a decrease in torque.

Thus, there is a demand for a lightweight rotor core, rotor, and electric motor which can reduce inertia and sufficiently magnetize without reducing torque.

### SUMMARY

According to a first aspect of the present disclosure, there is provided a rotor core, wherein a plurality of pairs of magnet slots which extend in an axial direction of the rotor core are formed in the rotor core, the plurality of pairs of magnet slots are arranged at equal intervals in a circumferential direction of the rotor core in a radial cross-section of the rotor core, each pair of magnet slots of the plurality of pairs of magnet slots comprises a first magnet slot which is inclined counterclockwise relative to a radius of the rotor core and a second magnet slot which is inclined clockwise relative to the radius of the rotor core, in each pair of magnet slots, one end of the first magnet slot and one end of the second magnet slot are spaced apart from each other, and the other end of the first magnet slot and the other end of the second magnet slot are adjacent to each other at a radially inner side of the rotor core relative to the one end of the first magnet slot and the one end of the second magnet slot, a first hole is formed adjacent to each pair of magnet slots, and each of the first holes comprises a first portion corresponding to at least a part of an area between the other end of the first magnet slot and the other end of the second magnet slot, and a second portion which is continuous with the first portion and which is positioned at a radially inner side of the rotor core relative to the first portion.

The objects, features, and advantages of the present disclosure will become more apparent from the following description of embodiments in conjunction with the attached drawings.

### BRIEF DESCRIPTION OF DRAWINGS

FIG. 1 is an axial cross-sectional view of an electric motor comprising a rotor core according to the present disclosure.

FIG. 2 is a radial cross-sectional view of a rotor core based on a first embodiment.

FIG. 3 is a partial cross-sectional view of the rotor core shown in FIG. 2.

FIG. 4 is an enlarged partial cross-sectional view of a portion of FIG. 3.

FIG. 5 is a radial cross-sectional view of a rotor core similar to FIG. 2.

FIG. 6 is another partial cross-sectional view of the rotor core shown in FIG. 2.

FIG. 7 is an enlarged partial cross-sectional view of a portion of FIG. 6.

FIG. 8A is a partial cross-sectional view showing the magnetic flux of an electric motor of the prior art.

FIG. 8B is a view showing the relationship between time and torque of the electric motor of the prior art.

FIG. 9A is a partial cross-sectional view showing the magnetic flux of the electric motor based on the first embodiment.

FIG. 9B is a view showing the relationship between time and torque of the electric motor based on the first embodiment.

FIG. 10A is a partial cross-sectional view showing the magnetization rate of the electric motor of the prior art.

FIG. 10B is a partial cross-sectional view showing the magnetization rate of the electric motor based on the first embodiment.

### DESCRIPTION OF EMBODIMENTS

Embodiments of the present disclosure will be described below with reference to the attached drawings. In the drawings, corresponding constituent elements have been assigned common reference signs.

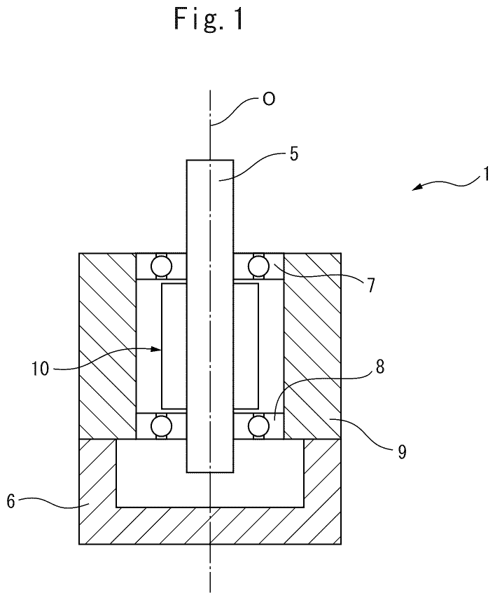

FIG. 1 is an axial cross-sectional view of an electric motor comprising a rotor core according to the present disclosure. As shown in FIG. 1, the electric motor 1 comprises a stator 9 and a rotor 10 which is rotatably supported by the stator 9. A first bearing 7 and a second bearing 8 are arranged on the inner peripheral surface of the stator 9. A shaft part 5 which passes through the rotor 9 is rotatably supported by the stator 9 via the first bearing 7 and the second bearing 8. A detector 6 for detecting the rotation speed of the shaft part 5 is attached to one end of the stator 9.

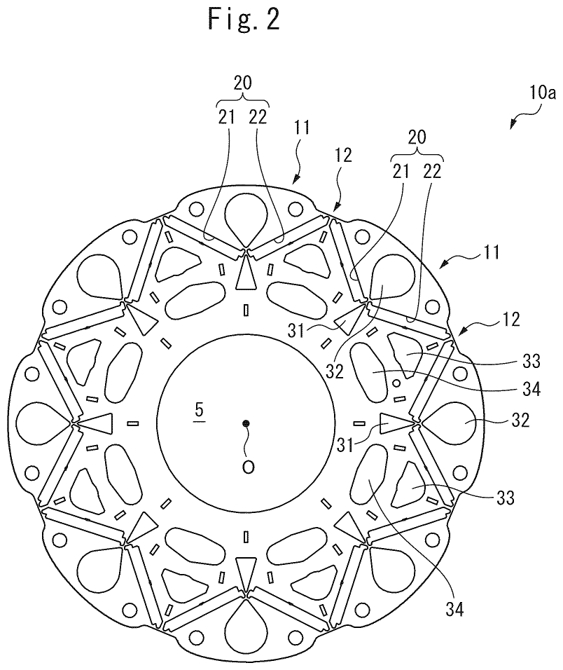

FIG. 2 is a radial cross-sectional view of the rotor core based on the first embodiment. The rotor core 10a shown in FIG. 2 is generally annular with a through-hole in the center for the shaft part 5. However, as will be described later, it is preferable that the outer peripheral surface of the rotor core 10a not be smooth. Furthermore, the rotor core 10a is typically formed by laminating a plurality of magnetic plates, such as iron plates, carbon steel plates, or electromagnetic steel plates, in the shape shown in FIG. 2, or by using a powder iron core.

A plurality of pairs of magnet slots 20 which extend in the axial direction of the rotor core 10a are formed in the rotor core 10a at equal intervals in the circumferential direction. Each pair of magnet slots 20 includes a first magnet slot 21 which is inclined counterclockwise relative to the radius of the rotor 10, and a second magnet slot 22 which is inclined clockwise relative to the radius of the rotor 10. The absolute values of the inclination angles of the first magnet slot 21 and the second magnet slot 22 relative to the radius are preferably equal to each other.

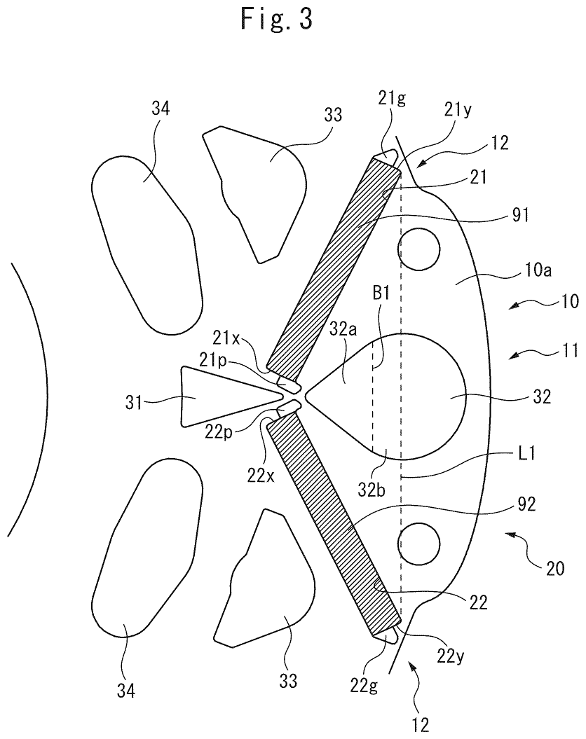

FIG. 3 is a partial cross-sectional view of the rotor core shown in FIG. 2. Permanent magnets 91, 92 are inserted into the magnet slots 21, 22 of the rotor core 10a, respectively. Thus, the magnet slots 21, 22 are preferably substantially rectangular in shape corresponding to the shapes of the permanent magnets 91, 92, and are preferably identical to each other in shape. For the purpose of simplification, the permanent magnets 91, 92 may be omitted from the drawings.

Each pair of magnet slots 20 is arranged so as to converge toward the inside of the rotor core 10a in the radial direction. In other words, the magnet slots 21, 22 are formed so as to form a substantially V-shape. In the present disclosure, the angle formed by the magnet slots 21, 22 in each pair of magnet slots 20 is an obtuse angle, for example, 120°. It should be noted that these magnet slots 21, 22 need not be connected to each other on the radially inner side of the rotor core 10a.

Furthermore, in FIG. 2, the outer periphery of the rotor core 10a is composed of a plurality of first outer peripheral portions 11 and a plurality of second outer peripheral portions 12 which are respectively connected to the plurality of first outer peripheral portions 11. Specifically, the plurality of first outer peripheral portions 11 and the plurality of second outer peripheral portions 12 are arranged alternatingly in the circumferential direction of the rotor core 10a. As can be understood from FIG. 2, each of the plurality of first outer peripheral portions 11 roughly corresponds to a respective area of the plurality of pairs of magnet slots 20. Strictly speaking, each of the first outer peripheral portions 11 corresponds to the other end 21x of the magnet slot 21 and the other end 22x of the second magnet slot 22 on the radially inner side of the rotor core 10a. The plurality of second outer peripheral portions 12 each correspond to an area between two adjacent pairs of magnet slots 20 among the plurality of pairs of magnet slots 20. Strictly speaking, aa of the second outer peripheral portion 12 corresponds to one end 21y of the magnet slot 21 and one end 22y of the second magnet slot 22 on the radially outer side of the rotor core 10a.

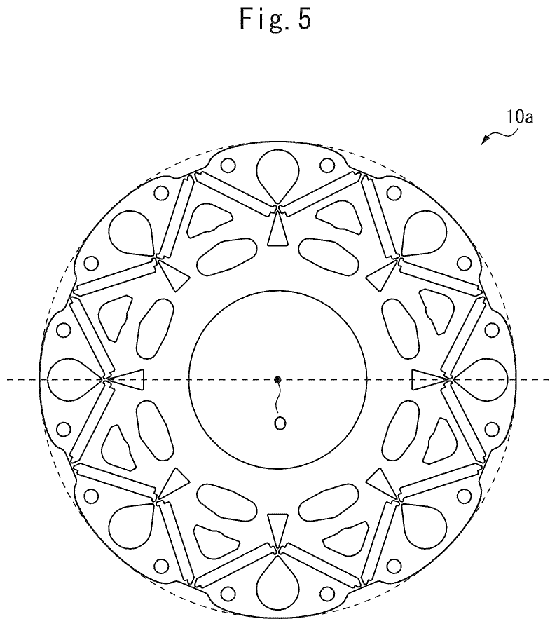

Furthermore, the outermost portion of each first outer peripheral portion 11 is positioned radially outward of the rotor core 10a relative to the outermost portion of each second outer peripheral portion 12. In other words, the plurality of first outer peripheral portions 11 as convex portions and the plurality of second outer peripheral portions 12 as concave portions are arranged alternatingly in the circumferential direction of the rotor core 10a. The entirety of each first outer peripheral portion 11 is positioned inside a circle the radius of which is a line segment connecting the center O of the rotor core 10a and the outermost portion of the first outer peripheral portion 11. In FIG. 5, which is a radial cross-sectional view of the rotor core similar to FIG. 2, this circle is represented by a dashed line.

In this manner, since the outer periphery of the rotor core 10a is not a perfect circle, the change in the magnetic flux linkage is small when the electric motor 1 comprising the rotor core 10a is driven, and as a result, increases in cogging torque and torque ripple can be prevented. Thus, in the first embodiment of the present invention, controllability of the electric motor 1 comprising the rotor core 10a can be improved.

Furthermore, in FIG. 2, the outermost portion of each first outer peripheral portion 11 is composed of at least one curve. In one example, the first outer peripheral portion 11 is defined by the formula r=D−E/cos(Fθ) (where D, E, and F are positive numbers). In this case, the first outer peripheral portion 11 is positioned reliably inside the circle described above and is smooth. Furthermore, the outermost portion of each second outer peripheral portion 12 may be composed of at least one straight line.

In an unillustrated embodiment, the outermost portion of each first outer peripheral portion 11 may be formed by at least one straight line, and the outermost portion of each second outer peripheral portion 12 may be formed by at least one curved line. Furthermore, both the outermost portion of the first outer peripheral portion 11 and the outermost portion of the second outer peripheral portion 12 may be formed by at least one straight line, or both the outermost portion of the first outer peripheral portion 11 and the outermost portion of the second outer peripheral portion 12 may be formed by at least one curved line. Furthermore, at least one of the outermost portion of the first outer peripheral portion 11 and the outermost portion of the second outer peripheral portion 12 may be formed by at least one straight line and at least one curved line. In such a case, since the outermost portions of the plurality of first outer peripheral portions 11 are positioned radially outward of the rotor core 10a relative to the outermost portions of the plurality of second outer peripheral portions 12, the outer periphery of the rotor core 10a has a shape which is different from a perfect circle. Thus, it can be understood that the same effects as described above can be obtained.

Further, in an unillustrated modification example of the first embodiment, the first outer peripheral portion 11 may be positioned radially inward of the rotor core 10a relative to the second outer peripheral portion 12. Even in such a case, the same effects as described above can be obtained, and this is included in the scope of the first embodiment.

As shown in FIG. 2, a plurality of first holes 31 extending in the axial direction of the rotor core 10a are formed in the end surface of the rotor core 10a at equal intervals in the circumferential direction. As can be understood from FIGS. 2 and 3, each of the plurality of first holes 31 is formed in an area of the rotor core 10a corresponding to the first outer peripheral portion 11. Strictly speaking, the first holes 31 are formed on one radius of the rotor core 10a between the first magnet slot 21 and the second magnet slot 22 of the pair of magnet slots 20. The shape of the first holes 31 will be described later.

A plurality of second holes 32 are formed in the end surface of the rotor core 10a at equal intervals in the circumferential direction. Each of the second holes 32 is formed on the same radius as described above. Thus, the first holes 31 and the second holes 32 are arranged side by side on the same radius of the rotor core 10a. Therefore, as can be understood from FIG. 3, the second holes 32 are formed radially outward of the first holes 31 on the rotor core 10a. Strictly speaking, the first holes 31 are formed radially inward of the pair of magnet slots 20 on the rotor core 10a, and the second holes 32 are formed radially outward of the pair of magnet slots 20 on the rotor core 10a. The shape of the second holes 32 will be described later.

Furthermore, as can be understood from FIG. 2, plurality of sets composed of a third hole 33 and a fourth hole 34 are formed at equal intervals in the circumferential direction of the rotor core 10a. A set of a third hole 33 and a fourth hole 34 is formed between two adjacent pairs of magnet slots 20 among the plurality of pairs of magnet slots 20. The third holes 33 and fourth holes 34 are arranged side by side on the same radius of the rotor core 10a. The third holes 33 are formed radially outward of the fourth holes 34 on the rotor core 10a. The shapes of the third holes 33 and fourth holes 34 will be described later.

The first holes 31 will be described. As shown in FIG. 3, the first holes 31 are substantially isosceles triangles having an acute apex angle. The apex angle side of the substantially isosceles triangle is positioned radially outward of the rotor core 10a, and the base side of the substantially isosceles triangle is positioned radially inward of the rotor core 10a. The base of the substantially isosceles triangle is perpendicular to one radius of the rotor core 10a.

The reason for using the term “substantially isosceles triangle” is that it encompasses cases which differ from a perfect isosceles triangle, such as when the vertex portion of the isosceles triangle is rounded, when each of the two hypotenuses of the isosceles triangle is composed of plurality of straight lines, or when each of the two hypotenuses of the isosceles triangle includes a curve. The same applies to the other holes 32, 33, 34.

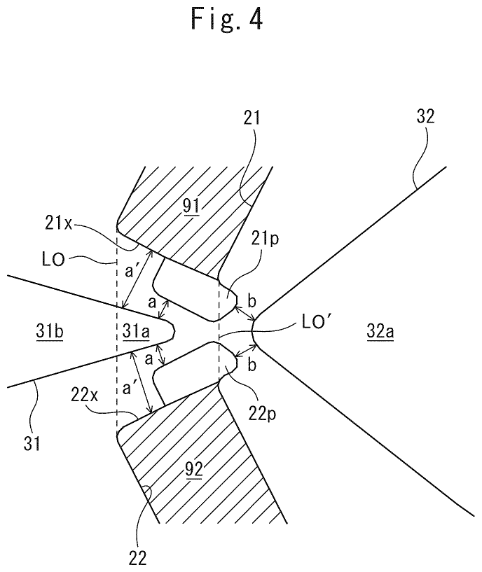

FIG. 4 is an enlarged partial cross-sectional view of a portion of FIG. 3. As can be understood from FIGS. 3 and 4, the first hole 31 is composed of a first portion 31a including the acute angle of the substantially isosceles triangle and a second portion 31b including the base of the substantially isosceles triangle. The first portion 31a has a shape similar to that of the first hole 31. The boundary between the first portion 31a and the second portion 31b is preferably parallel to the base.

As shown in FIG. 4, the boundary line between the first portion 31a and the second portion 31b corresponds to one portion of a line segment L0 connecting the other end 21x of the first magnet slot 21 on the radially inner side of the rotor core 10a and the other end 22x of the second magnet slot 22. Strictly speaking, the line segment L0 connects one portion of the other end 21x of the first magnet slot 21, which is positioned at the radially innermost position of the rotor core 10a, and one portion of the other end 22x of the second magnet slot 22, which is positioned at the radially innermost position of the rotor core 10a.

It is preferable that the other end 21x of the first magnet slot 21 and the hypotenuse of the substantially isosceles triangle adjacent thereto be substantially parallel to each other. Likewise, it is preferable that the other end 22x of the first magnet slot 22 and the hypotenuse of the substantially isosceles triangle adjacent thereto be substantially parallel to each other.

In this manner, the first hole 31 in the present disclosure is formed adjacent to the area between the first magnet slot 21 and the first magnet slot 22. The first portion 31a of the first hole 31 is formed between the other end 21x of the first magnet slot 21 and the other end 22x of the second magnet slot 22. Furthermore, the second portion 31b of the first hole 31 is formed radially inward of the rotor core 10a than the first portion 31a.

In other words, the first hole 31 according to the present disclosure always includes the second portion 31b in addition to the first portion 31a formed between the first magnet slot 21 and the second magnet slot 22. Thus, in the present disclosure, a large first hole 31 can be formed. As a result, the rotor core 10a can be made lighter, and the electric motor 1 can be made faster.

Furthermore, as shown in FIG. 3, a space 21g is formed in the one end 21y side of the first magnet slot 21. The space 21g is formed so as to partially protrude from the one end 21y along a length portion of the first magnet slot 21. A space 22g of a similar shape is formed on one end 22y side of the second magnet slot 22.

Furthermore, a space 21p is also formed on the other end 21x side of the first magnet slot 21. Likewise, a space 22p is formed on the other end 22x side of the second magnet slot 22. The spaces 21p, 22p partially protrude from the other ends 21x, 22x along the length portions of the first magnet slot 21 and the second magnet slot 22.

The spaces 21g, 21p of the first magnet slot 21 and the spaces 22g, 22p of the second magnet slot 22 function as flux barriers which suppress magnetic flux leakage to the rotor core from both longitudinal ends of the magnets 91, 92. The spaces 21g, 22g, 21p, 22p also function to facilitate insertion and removal of the permanent magnets 91, 92 into/from the corresponding magnet slots 21, 22. Furthermore, the formation of the spaces 21g, 21p, 22g, 22p reduces the weight of the rotor core 10a.

FIG. 4 shows line segment L0′, which connects one portion of the other end 21x of the first magnet slot 21 on the radially outer side of the rotor core 10a to one portion of the other end 22x of the second magnet slot 22 on the radially outer side of the rotor core 10a. As can be understood from FIG. 4, the spaces 21p, 22p each partially protrude beyond the line segment L0′ to the radially outer side of the rotor core 10a. In other words, the spaces 21p, 22p are formed to protrude from the other ends 21x, 22x in both a direction perpendicular to the length portions of the first magnet slot 21 and second magnet slot 22 and in the length direction of the magnet slots 21, 22, respectively. It should be noted that the spaces 21p, 22p are connected to the first magnet slot 21 and the second magnet slot 22, respectively. As can be understood from the drawing, the spaces 21p, 22p are not connected to each other.

As shown in FIG. 4, the shortest distance between the space 21p at the other end 21x of the first magnet slot 21 and the first hole 31 is defined as distance a. The shortest distance between the space 22p at the other end 22x of the second magnet slot 22 and the first hole 31 is also defined as distance a. The shortest distance between the other end 21x of the first magnet slot 21 and the first hole 31 is defined as distance a′. The shortest distance between the other end 22x of the second magnet slot 22 and the first hole 31 is also defined as distance a′. The distance a can be equal to or less than half of the distance a′, preferably one-fourth or less. In a typical example, the distance a is greater than 0 and equal to or less than 1 millimeter.

As described above, the angle between the magnet slots 21, 22 is an obtuse angle, and in such a case, it is difficult for the electric motor 1 comprising the rotor core 10a to output high torque. However, the first hole 31 and the spaces 21p, 22p having the shapes and dimensions described above are formed in the rotor core 10a of the present disclosure. Thus, magnetic flux leakage when the electric motor 1 is driven is reduced, whereby the torque of the electric motor 1 can be maintained at a high level even when the angle between the magnet slots 21, 22 is an obtuse angle. Furthermore, by forming the first holes 31 and the spaces 21p, 22p, the weight of the rotor core 10a can be reduced.

During magnetization, the rotor 10 is arranged in the inner cylinder of the magnetizing yoke (not illustrated) in a state in which the magnets 91, 92 are inserted into all of the magnet slots 21, 22. At this time, a portion of the magnets 91, 92 positioned radially inward of the rotor 10 is located distant from the magnetizing yoke. Thus, it is difficult to sufficiently magnetize up to this portion of the magnets 91, 92, in particular, when the angle between the first magnet slot 21 and the second magnet slot 22 is acute.

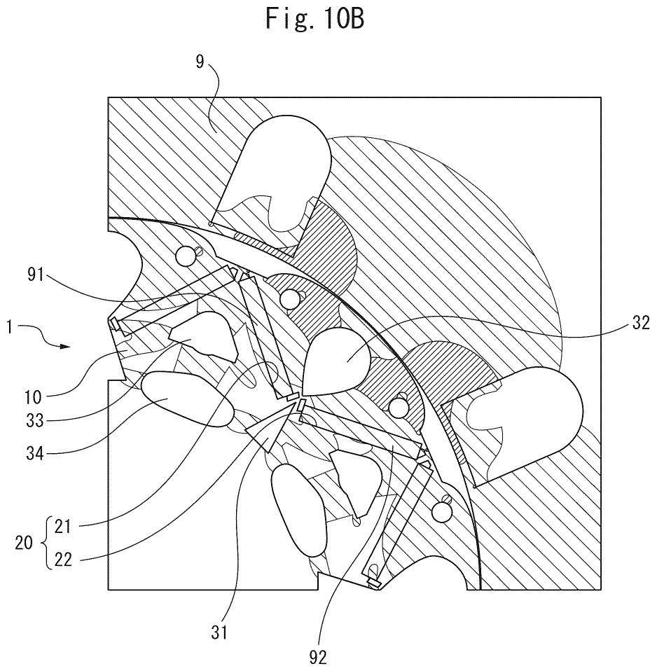

However, when compared to the case in which the angles between the magnet slots are acute angles, since the angles between the magnet slots 21, 22 are obtuse angles in the present disclosure, the other ends 21x, 22x of the magnet slots 21, 22 are positioned relatively close to the outer peripheral surface of the rotor core 10a. Thus, in the present disclosure, it is relatively easy to magnetize up to the portion of the magnets 91, 92 positioned near the other ends 21x, 22x of the magnet slots 21, 22. In other words, in the present disclosure, the angles between the magnet slots 21, 22 can be made obtuse, which has the additional advantage of making it easier to magnetize the magnets. This will be described later using FIGS. 10A and 10B.

Next, the second holes 32 will be described. As shown in FIG. 3, the first holes 31 and the second holes 32 are arranged side by side on the same radius of the rotor core 10a. The first holes 31 are formed radially inward of the pair of magnet slots 20 of the rotor core 10a, and the second holes 32 are formed radially outward of the pair of magnet slots 20 of the rotor core 10a.

Each second hole 32 is composed of a first portion 32a and a second portion 32b positioned radially outward of the rotor core 10a relative to the first portion 32a. The boundary line between the first portion 32a and the second portion 32b of the second hole 32 is preferably parallel to the base of the substantially isosceles triangle of the first hole 31.

As shown in FIG. 3, the first portion 32a is substantially isosceles triangle shaped with the apex angle thereof pointing toward the center O of the rotor core 10a. The apex angle of the substantially isosceles triangle of the first portion 32a is an acute angle and is preferably greater than the apex angle of the substantially isosceles triangle of the first portion 31a of the first hole 31. The second portion 32b has an arc shape, such as a semicircular arc, which protrudes from the base of the isosceles triangle radially outward of the rotor core 10a. The first portion 32a and the second portion 32b are preferably smoothly connected to each other. In other words, at the connection point between the first portion 32a and the second portion 32b, the hypotenuse of the substantially isosceles triangle of the first portion 32a and the tangent to the second portion 32b are preferably equal to each other. It should be noted that the arc of the second portion 32b may be longer or shorter than the semicircular arc. The arc serving as the second portion 32b may be an elliptical arc.

In FIG. 3, the line segment connecting one end 21y of the first magnet slot 21 and one end 22y of the second magnet slot 22 on the radially outer side of the rotor core 10a is referred to as a first line segment L1. Strictly speaking, the first line segment L1 connects one portion of the end 21y of the first magnet slot 21 positioned at the radially outermost position of the rotor core 10a to one portion of the end 22y of the second magnet slot 22 positioned at the radially outermost position of the rotor core 10a. As can be understood from FIG. 3, a boundary line B1 between the first portion 32a and the second portion 32b of the second hole 32 is preferably parallel to the first line segment L1 and positioned inward of the first line segment L1 in the radial direction of the rotor core 10a.

In other words, at least one portion of the second portion 32b of the second hole 32 is positioned radially outward of the rotor core 10a relative to the first line segment L1. Thus, in the present disclosure, a large second hole 32 can be formed, resulting in a reduction in the weight of the rotor core 10a and an increase in the speed of the electric motor 1. Furthermore, since the second portion 32b is an arc, the flow of magnetic flux is not obstructed when the electric motor 1 comprising the rotor core 10a is driven. It should be noted that in order to increase the area of the second hole 32, the boundary line B1 may be on the first line segment L1, or the boundary line B1 may be positioned outward of the first line segment L1 in the radial direction of the rotor core 10a.

As described above, it is preferable that the first outer peripheral portion 11 in which the second hole 32 is formed protrude outward more than the second outer peripheral portion 12 in the radial direction of the rotor core 10a. In this case, the second hole 32 can be formed longer outward in the radial direction of the rotor core 10a by the protruding portion of the first outer peripheral portion 11. Thus, it will be understood that the second hole 32 can be made larger, and the rotor core 10a can be made lighter accordingly.

As shown in FIG. 4, the shortest distance between the space 21p at the other end 21x of the first magnet slot 21 and the second hole 32 is defined as distance b. The shortest distance between the space 22p of the other end 22x of the second magnet slot 22 and the second hole 32 is also defined as distance b. These distances b are measured from one portion of the spaces 21p, 22p protruding radially outward of the rotor core 10a beyond the line segment L0′ to the second hole 32.

The distance b can also be equal to or less than half, preferably one-fourth or less, of the distance a′. In a typical example, the distance a is greater than 0 and equal to or less than 1 mm. As a result, the same effects as described above can be obtained.

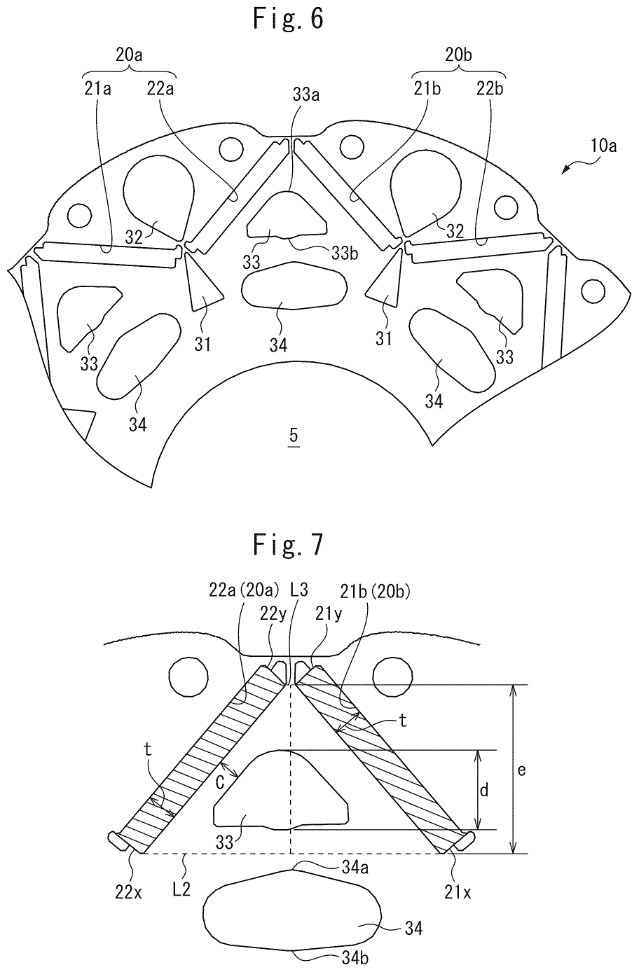

Next, the third holes 33 will be described. FIG. 6 is another partial cross-sectional view of the rotor core shown in FIG. 2. As shown in FIG. 6, one pair of magnet slots 20a comprises a first magnet slot 21a and a second magnet slot 22a. Another pair of magnet slots 20b comprises a first magnet slot 21b and a second magnet slot 22b. A third hole 33 is formed between the second magnet slot 22a of the magnet slot 20a and the first magnet slot 21b of the magnet slot 20b.

As can be understood from FIG. 6, the third hole 33 is substantially isosceles triangle shaped, for example, an obtuse isosceles triangle, the apex angle 33a of which is defined by a circular arc. The apex angle 33a of the substantially isosceles triangle of the third hole 33 faces radially outward of the rotor core 10a. Furthermore, it is preferable that the two hypotenuses of the substantially isosceles triangle of the third hole 33 be parallel to the second magnet slot 22a and the first magnet slot 21b, respectively.

Furthermore, the portions of the third hole 33 corresponding to the two base angles of the substantially isosceles triangle may be omitted, and the hypotenuse and the base may be connected near the base. In FIG. 6, the portions corresponding to the base angles are configured as right angles. Alternatively, the portions corresponding to the base angles may be configured as arcs. By forming the third hole 33 in this manner, the flow of magnetic flux is not obstructed.

Furthermore, there may be formed a protrusion 33b which protrudes radially inward of the rotor from the base of the substantially isosceles triangle of the third hole 33. The protrusion 33b is preferably formed approximately in the center of the base of the substantially isosceles triangle.

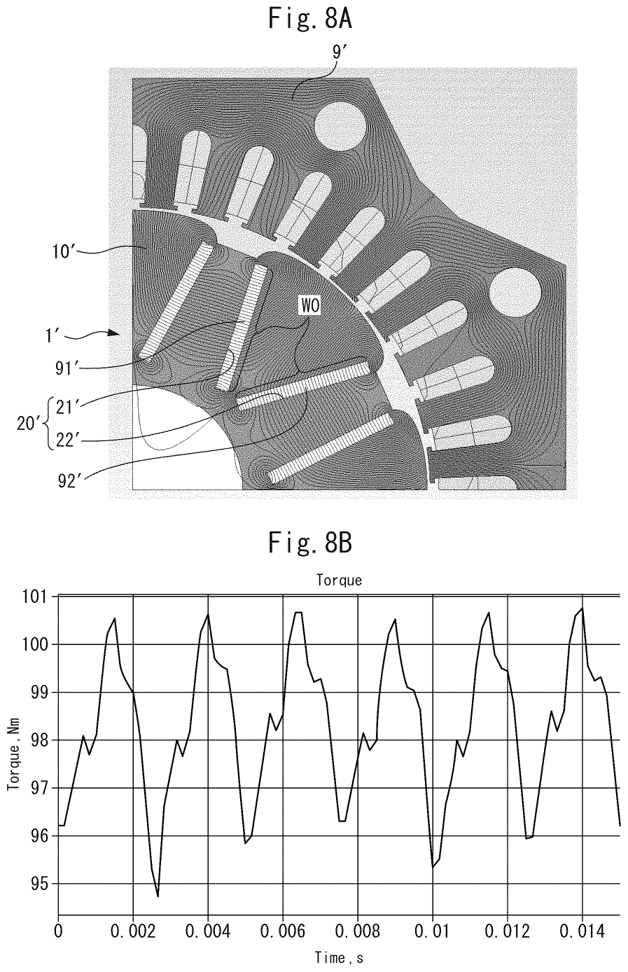

FIG. 7 is a partial cross-sectional view showing an enlarged portion of FIG. 6. FIG. 7 primarily shows the second magnet slot 22a of the one pair of magnet slots 20a and the first magnet slot 21b of the other pair of magnet slots 20b. The line segment connecting the other end 22x of the second magnet slot 22a and the other end 21x of the first magnet slot 21b on the radially inner side of the rotor core 10a is defined as a second line segment L2. Strictly speaking, the second line segment L2 connects the portion of the other end 22x of the second magnet slot 22a positioned radially innermost on the rotor core 10a to a portion of the other end 22y of the first magnet slot 21b positioned radially innermost on the rotor core 10a. The entire third hole 33 is positioned more radially outside of the rotor core 10a than the second line segment L2.

As shown in FIG. 7, the third hole 33 is formed in an area surrounded by the second magnet slot 22a of the one pair of magnet slots 20a, the first magnet slot 21b of the other pair of magnet slots 20b, and the second line segment L2. In other words, the third hole 33 is not formed on or near the second line segment L2. Thus, the strength of the rotor core 10a can be secured. Furthermore, it can be understood that the flow of magnetic flux is not obstructed when the electric motor 1 comprising the rotor core 10a is driven.

Furthermore, as shown in FIG. 7, the third hole 33 is formed between the second magnet slot 22a of the one pair of magnet slots 20a and the first magnet slot 21b of the other pair of magnet slots 20b. The shortest distance between the third hole 33 and the first magnet slot 21b is greater than a shortest distance c between the third hole 33 and the second magnet slot 22a.

The shortest distance c is preferably equal to or greater than half the thickness t of the magnets 91, 92. In a typical example, the shortest distance is equal to or greater than 2 millimeters. When the third hole 33 is spaced apart from the magnets 91, 92 by equal to or greater than half the thickness t of the magnets 91, 92, the magnetization described above can be achieved without being affected by the third hole 33.

Further, as shown in FIG. 7, the line segment connecting one end 22y of the second magnet slot 22a and one end 21y of the first magnet slot 21b on the radially inner side of the rotor core 10a is defined as a third line segment L3. Strictly speaking, the third line segment L3 connects the portion of the one end 21y of the first magnet slot 22a positioned at the radially innermost position of the rotor core 10a to the portion of the one end 22y of the second magnet slot 21b positioned at the radially innermost position of the rotor core 10a.

The third line segment L3 and the second line segment L2 are parallel to each other. The third hole 33 has a dimension d, on the center line between the second magnet slot 22a and the first magnet slot 21b, which corresponds to the radius of the rotor core 10a. The dimension d need not necessarily be on the center line of the third hole 33. Furthermore, the dimension between the second line segment L2 and the third line segment L3 is defined as a dimension e. In such a case, the dimension e is preferably equal to or greater than twice the dimension d.

The reason this shape and arrangement are selected for the third hole 33 is to ensure the strength of the area between the third hole 33 and the second magnet slot 22a and the first magnet slot 21b, as well as to smooth the flow of magnetic flux. Furthermore, in the electric motor 1 comprising this rotor core 10 a, inertia can be reduced.

Next, the fourth holes 34 will be described. As can be understood from FIG. 7, the third holes 33 and the fourth holes 34 are juxtaposed on a radius of the rotor core 10a passing through the center between the second magnet slot 22a of the one pair of magnet slots 20a and the first magnet slot 21b of the other pair of magnet slots 20b. A set composed of a third hole 33 and a fourth hole 34 is formed between two adjacent pairs of magnet slots 20a, 20b among the plurality of pairs of magnet slots 20. The third holes 33 and the fourth holes 34 may be formed line-symmetrically relative to the radius described above. Furthermore, each fourth hole 34 is formed radially inward of the rotor core 10a relative to the second line segment L2.

Each fourth hole 34 has a generally oval or elliptical shape, with the major axis thereof parallel to the line segment L2. Furthermore, each fourth hole 34 preferably includes protrusions 34a, 34b extending along the radius described above. As shown in FIG. 7, the protrusion 34a extends radially outward of the rotor core 10a, and the protrusion 34b extends radially inward of the rotor core 10a. By forming these protrusions 34a, 34b, the fourth hole 34 can be enlarged, thereby reducing the weight of the rotor core 10a. It should be noted that one of the protrusions 34a, 34b may be omitted.

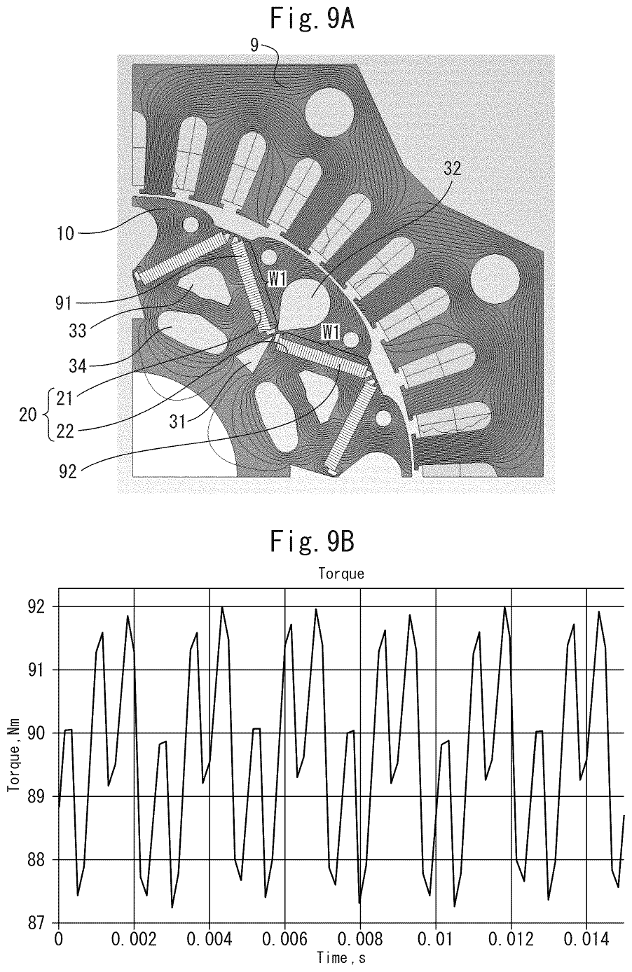

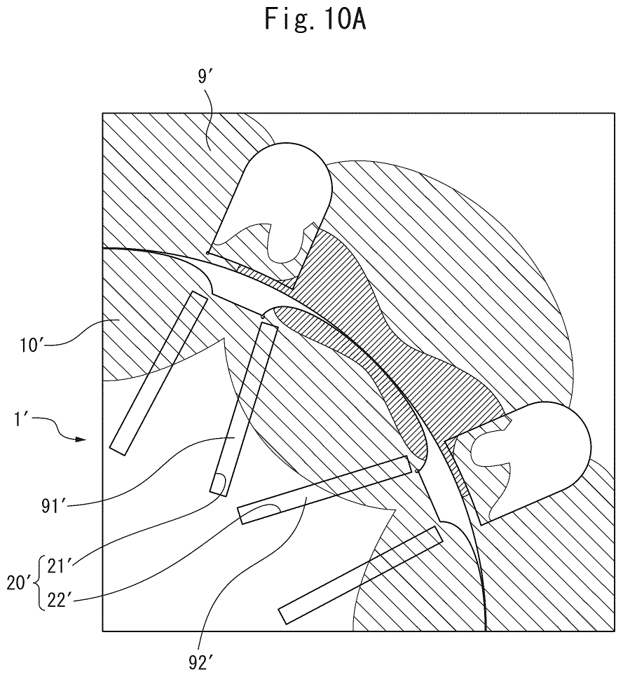

FIG. 8A is a partial cross-sectional view showing the magnetic flux of the electric motor of the prior art, and FIG. 9A is a partial cross-sectional view showing the magnetic flux of an electric motor comprising the rotor core based on the first embodiment. The electric motor 1′ shown in FIG. 8A comprises a stator 9′ and a rotor 10′. The rotor 10′ does not have the first hole 31 to the fourth hole 34 formed therein. On the other hand, the electric motor 1 shown in FIG. 9A comprises the stator 9 and the rotor 10 described above. Since the structures of the rotors 10 and 10′ are well known, description thereof has been omitted.

As can be understood by comparing FIGS. 8A and 9A, even when first hole 31 to fourth hole 34 are formed, in the manner of the electric motor 1, the flow of magnetic flux is not obstructed by the first hole 31, etc. Furthermore, the electric motor 1 is lighter than the electric motor 1′ by the amount for forming the first hole 31 to the fourth hole 34.

Furthermore, the angle formed by the first magnet slot 21′ and the second magnet slot 22′ of the pair of magnet slots 20′ of FIG. 8A is an acute angle, for example, 60°. Thus, the number of magnets 91′, 92′ inserted into the first magnet slot 21′ and the second magnet slot 22′, respectively, is greater than the number of magnets 91, 92 shown in FIG. 9A.

The diameter of the rotor 10′ shown in FIG. 8A is equal to the diameter of the rotor 10 shown in FIG. 9A. However, while the width W0 of the magnets 91′, 92′ shown in FIG. 8A is, for example, 31.4 mm, the width W1 of the magnets 91, 92 shown in FIG. 9A may be, for example, 22.5 mm.

In this manner, in the present disclosure, the number of magnets 91, 92 can be reduced as compared to the prior art, and the dimensions of the magnets 91, 92 can be reduced. As a result, it will be understood that the electric motor 1 can be made significantly lighter than the electric motor 1′. In the illustrated embodiment, the total weight of the magnets 91, 92 of the electric motor 1 can be, for example, about 28% less than the total weight of the magnets 91′, 92′ of the electric motor 1′.

Furthermore, FIG. 8B is a view showing the relationship between time and torque in the electric motor of the prior art, and FIG. 9B is a view showing the relationship between time and torque of the electric motor of the first embodiment. In these drawings, the horizontal axis represents time, and the vertical axis represents the torque of electric motor 1, 1′. In FIG. 8B, the maximum torque value of the electric motor 1′ is between 100 Nm and 101 Nm. In contrast, in FIG. 9B, the maximum torque value of the electric motor 1 is between 91.5 Nm and 92 Nm. In other words, even when first hole 31 through fourth hole 34 are formed, the decrease in torque is maintained as less than 10%.

Even when the first hole 31 to the fourth hole 34 are formed in the rotor 10 in this manner, torque is not significantly reduced and practical torque can be generated. It will also be apparent to a person skilled in the art that the same effects can be obtained even when only one of the first hole 31 to the fourth hole 34 is formed.

Furthermore, the ratio of the D-phase current to the stall current of the electric motor 1 and the electric motor 1′ is expressed as a percentage as follows:

TABLE 1

| Rotation speed, rpm | 2000 | 2500 | 3000 | 3500 |
|---|---|---|---|---|
| Electric motor 1 | 0.0 | 54.3 | 108.7 | 134.0 |
| Electric motor 1′ | 49.1 | 171.9 | 196.0 | 196.0 |

From this table, it can be understood that while the electric motor 1′ exceeded its limit at a rotation speed of 2500 rpm, the electric motor 1 could operate stably even when the rotation speed is increased to, for example, 3000 rpm. This is because the D-phase current is relatively small in the electric motor 1. Furthermore, copper loss, which increases in proportion to the square of the load current, is also suppressed in the electric motor 1 as compared to the electric motor 1′. Thus, the electric motor 1 of the present disclosure is capable of higher speed rotation.

FIG. 10A is a partial cross-sectional view showing the magnetization rate of the electric motor of the prior art, and FIG. 10B is a partial cross-sectional view showing the magnetization rate of the electric motor of the first embodiment. These drawings show three levels of magnetization rate, with the higher the magnetization rate, the darker the area of that magnetization rate. Specifically, areas with low magnetization rate (magnetic flux density 0.0 T to 1.7 T) are shown in white, areas with medium magnetization rate (magnetic flux density 2.2 T to 3.3 T) are shown in light color, and areas with high magnetization rate (magnetic flux density 3.5 T to 5.0 T) are shown in dark color.

In the electric motor 1′ of the prior art shown in FIG. 10A, only a portion of the magnets 91′, 92′ positioned radially outward of the rotor 10′ is magnetized, the other portions of the magnets 91′, 92′ positioned radially inward are not magnetized. Because the angle between the first magnet slot 21 and the second magnet slot 22, into which the magnets 91′, 92′ are inserted, is acute, the distance between the other ends of the magnets 91′, 92′ positioned radially inward of the rotor 10′ and the outer circumferential surface of the rotor 10′ is long. Thus, in the prior art, even if the rotor 10′ is arranged inside a magnetizing yoke (not illustrated), it is difficult to magnetize the magnets 91′, 92 up to the other ends thereof”. Therefore, in the prior art, the magnetization rate of the magnets 91′, 92′ is approximately 30%.

Conversely, in the electric motor 1 shown in FIG. 10B, the magnets 91, 92 are magnetized over almost their entire surfaces, and the magnetization rate of the magnets 91, 92 is approximately 100%. In other words, in the present disclosure, even if the rotor 10 is arranged inside a magnetizing yoke (not illustrated), the magnets 91, 92 can be sufficiently magnetized up to the other ends thereof on the radially inner side of the rotor 10. Therefore, in the present disclosure, in which the angle formed by the first magnet slot 21 and the second magnet slot 22 is an obtuse angle, the magnets 91, 92 can be reliably magnetized.

In the present disclosure, it is sufficient that the first hole 31 and the spaces 21p, 22p be formed, and it is not necessary to form the second hole 32 to the fourth hole 34. Furthermore, a configuration in which at least one of the second hole 32 to the fourth hole 34 is formed in addition to the first hole 33 and the spaces 21p, 22p is also included in the scope of the present disclosure.

Therefore, in at least one embodiment, by forming the first hole 31, etc., the weight of the rotor 10 can be reduced, and inertia can be reduced while sufficient magnetization is achieved without a significant decrease in torque. In other words, a lightweight rotor 10 in which inertia can be reduced and sufficient magnetization can be achieved without a decrease in torque can be provided. Therefore, high acceleration is possible for the electric motor 1 comprising the rotor 10.

Though the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

In relation to the embodiments and modification examples described above, the following addenda are further disclosed.

### (Addendum 1)

A rotor core (10a), wherein
a plurality of pairs of magnet slots (20) which extend in an axial direction of the rotor core (10a) are formed in the rotor core (10a),
the plurality of pairs of magnet slots (20) are arranged at equal intervals in a circumferential direction of the rotor core (10a) in a radial cross-section of the rotor core (10a),
each pair of magnet slots (20) of the plurality of pairs of magnet slots (20) comprises a first magnet slot (21) which is inclined counterclockwise relative to a radius of the rotor core (10a) and a second magnet slot (22) which is inclined clockwise relative to the radius of the rotor core (10a),
in each pair of magnet slots (20), one end of the first magnet slot (21) and one end of the second magnet slot (22) are spaced apart from each other, and the other end of the first magnet slot (21) and the other end of the second magnet slot (22) are adjacent to each other at a radially inner end of the rotor core (10a) relative to the one end of the first magnet slot (21) and the one end of the second magnet slot (22),
a first hole (31) is formed adjacent to each pair of magnet slots (20), and
each of the first holes (31) comprises a first portion (31a) corresponding to at least a part of an area between the other end of the first magnet slot (21) and the other end of the second magnet slot (22), and a second portion (31b) which is continuous with the first portion (31a) and which is positioned at a radially inner end of the rotor core (10a) relative to the first portion (31a).

### (Addendum 2)

The rotor core (10a) according to Addendum 1, wherein a space (21p, 22p) is formed in each of the other end of the first magnet slot (21) and the other end of the second magnet slot (22), and
each space (21p, 22p) partially protrudes radially outward of the rotor core (10a) beyond a line segment (L0′) connecting the other end of the first magnet slot (21) at the radially outer side of the rotor core (10a) and the other end of the second magnet slot (22) at the radially outer side of the rotor core (10a).

### (Addendum 3)

The rotor core (10a) according to Addendum 1 or 2, wherein a distance (a) between the space (21p, 22p) formed in the other end of the first magnet slot (21) and the first hole (31) is equal to or less than half a distance (a′) between the other end of the first magnet slot (21) and the first hole (31), and
a distance (a) between the space (21p, 22p) formed in the other end of the second magnet slot (22) and the first hole (31) is equal to or less than half a distance (a′) between the other end of the second magnet slot (22) and the first hole (31).

### (Addendum 4)

The rotor core (10a) according to any one of Addenda 1 to 3, wherein an outer periphery of the rotor core (10a) is composed of a plurality of first outer peripheral portions (11) and a plurality of second outer peripheral portions (12) which are respectively connected to the plurality of first outer peripheral portions (11),
the plurality of first outer peripheral portions (11) respectively correspond to areas of the plurality of pairs of magnet slots (20),
the plurality of second outer peripheral portions (112) respectively correspond to the areas between two adjacent pairs of magnet slots (20a, 20b) among the plurality of pairs of magnet slots (20), and
outermost portions of the plurality of first outer peripheral portions (11) are positioned more radially outward of the rotor core (10a) than outermost portions of the plurality of second outer peripheral portions (12).

### (Addendum 5)

The rotor core (10a) according to any one of Addenda 1 to 4, wherein the plurality of first outer peripheral portions (11) are composed of at least one curve, and
the plurality of second outer peripheral portions (12) are composed of at least one straight line.

### (Addendum 6)

The rotor core (10a) according to any one of Addenda 1 to 5, wherein a second hole (32) is further formed adjacent to each pair of magnet slots (20), and
each of the first holes (31) and each of the second holes (32) are juxtaposed in the radial direction of the rotor core (10a).

### (Addendum 7)

The rotor core (10a) according to any one of Addenda 1 to 6, wherein each of the second holes (32) is composed of a substantially isosceles triangle, an apex angle (32a) thereof pointing toward a center of the rotor core (10a) in the radial cross-section of the rotor core (10a), and an arc protruding from a base of the isosceles triangle radially outward of the rotor core (10a), and
at least a portion of the arc of each of the second holes (32) is positioned radially outward of the rotor core (10a) relative to a first line segment (L1) connecting the one end of the first magnet slot (21) and the one end of the second magnet slot (22) at the radially outer side of the rotor core (10a).

### (Addendum 8)

The rotor core (10a) according to any one of Addenda 1 to 6, wherein a distance (b) between the space (21p, 22p) formed at the other end of the first magnet slot (21) and the second hole (32) is equal to or less than half a distance (a′) between the other end of the first magnet slot (21) and the first hole (31), and
a distance (b) between the space (21p, 22p) formed at the other end of the second magnet slot (22) and the second hole (32) is equal to or less than half a distance (a′) between the other end of the second magnet slot (22) and the first hole (31).

### (Addendum 9)

The rotor core (10a) according to any one of Addenda 1 to 8, wherein respective third holes (33) are formed between two adjacent pairs of magnet slots (20a, 20b) among the plurality of pairs of magnet slots (20), and
the third holes (33) are formed more radially outward of the rotor core (10a) than a second line segment (L2) connecting the other end of the second magnet slot (22a) in one pair of magnet slots (20a) of the two pairs of magnet slots (20a, 20b) and the other end of the first magnet slot (21b) in the other pair of magnet slots (20b) of the two pairs of magnet slots (20a, 20b).

### (Addendum 10)

The rotor core (10a) according to any one of Addenda 1 to 9, wherein a distance (c) between the third hole (33) and the first magnet slot (21) or the second magnet slot (22) is equal to or greater than half a thickness (t) of a magnet to be inserted into the first magnet slot (21) or the second magnet slot (22).

### (Addendum 11)

The rotor core (10a) according to any one of Addenda 1 to 10, wherein a distance (e) between a third line segment (L3) connecting one end of the second magnet slot (22a) of the one pair of magnet slots (20a) of the two pairs of magnet slots (20a, 20b) to one end of the first magnet slot (21b) of the other pair of magnet slots (20b) of the two pairs of magnet slots (20a, 20b) and the second line segment (L2) is equal to or greater than twice a length (d) of the third hole (33) in the radial direction of the rotor core (10a).

### (Addendum 12)

The rotor core (10a) according to any one of Addenda 1 to 11, wherein respective fourth holes (34) are formed radially inward of the third holes (33), and each of the third holes (33) and each of the fourth holes (34) are juxtaposed in the radial direction of the rotor core (10a).

### (Addendum 13)

A rotor (10), comprising:
the rotor core (10a) according to any one of Addenda 1 to 12,
magnets (91, 92) inserted in each of the plurality of pairs of magnet slots (20) (20), and
a shaft part (5) inserted in the rotor core.

### (Addendum 14)

An electric motor (1), comprising:
the rotor (10) according to Addendum 13, and
a stator (9) arranged around the rotor (10).

### DESCRIPTION OF REFERENCE SIGNS

1 electric motor
5 shaft part
9 stator
10 rotor
10a rotor core
11 first outer peripheral portion
12 second outer peripheral portion
20, 20a, 20b pair of magnet slots
21, 21a, 21b first magnet slot
21g,21p space
22, 22a, 22b second magnet slot
22g, 22p space
31 first hole
31a first portion
31b second portion
32 second hole
32a first portion
32b second portion
33 third hole
33a apex angle
33b protrusion
34 fourth hole
34a, 34b protrusion
91, 92 magnet
L0, L0′ line segment
L1 first line segment
L2 second line segment
L3 third line segment

1. A rotor core, wherein
a plurality of pairs of magnet slots which extend in an axial direction of the rotor core are formed in the rotor core,
the plurality of pairs of magnet slots are arranged at equal intervals in a circumferential direction of the rotor core in a radial cross-section of the rotor core,
each pair of magnet slots of the plurality of pairs of magnet slots comprises a first magnet slot which is inclined counterclockwise relative to a radius of the rotor core and a second magnet slot which is inclined clockwise relative to the radius of the rotor core,
in each pair of magnet slots, one end of the first magnet slot and one end of the second magnet slot are spaced apart from each other, and the other end of the first magnet slot and the other end of the second magnet slot are adjacent to each other at a radially inner side of the rotor core relative to the one end of the first magnet slot and the one end of the second magnet slot,
a first hole is formed adjacent to each pair of magnet slots, and
each of the first holes comprises a first portion corresponding to at least a part of an area between the other end of the first magnet slot and the other end of the second magnet slot, and a second portion which is continuous with the first portion and which is positioned at a radially inner side of the rotor core relative to the first portion.

2. The rotor core according to claim 1, wherein a space is formed in each of the other end of the first magnet slot and the other end of the second magnet slot, and
each space partially protrudes radially outward of the rotor core beyond a line segment connecting the other end of the first magnet slot at the radially outer side of the rotor core and the other end of the second magnet slot at the radially outer side of the rotor core.

3. The rotor core according to claim 2, wherein a distance between the space formed in the other end of the first magnet slot and the first hole is equal to or less than half a distance between the other end of the first magnet slot and the first hole, and
a distance between the space formed in the other end of the second magnet slot and the first hole is equal to or less than half a distance between the other end of the second magnet slot and the first hole.

4. The rotor core according to claim 1, wherein an outer periphery of the rotor core is composed of a plurality of first outer peripheral portions and a plurality of second outer peripheral portions which are respectively connected to the plurality of first outer peripheral portions,
the plurality of first outer peripheral portions respectively correspond to areas of the plurality of pairs of magnet slots,
the plurality of second outer peripheral portions respectively correspond to the areas between two adjacent pairs of magnet slots among the plurality of pairs of magnet slots, and
outermost portions of the plurality of first outer peripheral portions are positioned more radially outward of the rotor core than outermost portions of the plurality of second outer peripheral portions.

5. The rotor core according to claim 4, wherein the plurality of first outer peripheral portions are composed of at least one curve, and
the plurality of second outer peripheral portions are composed of at least one straight line.

6. The rotor core according to claim 1, wherein a second hole is further formed adjacent to each pair of magnet slots, and
each of the first holes and each of the second holes are juxtaposed in the radial direction of the rotor core.

7. The rotor core according to claim 6, wherein each of the second holes is composed of a substantially isosceles triangle, an apex angle thereof pointing toward a center of the rotor core in the radial cross-section of the rotor core, and an arc protruding from a base of the isosceles triangle radially outward of the rotor core, and
at least a portion of the arc of each of the second holes is positioned radially outward of the rotor core relative to a first line segment connecting the one end of the first magnet slot and the one end of the second magnet slot at the radially outer side of the rotor core.

8. The rotor core according to claim 6, wherein a distance between the space formed at the other end of the first magnet slot and the second hole is equal to or less than half a distance between the other end of the first magnet slot and the first hole, and
a distance between the space formed at the other end of the second magnet slot and the second hole is equal to or less than half a distance between the other end of the second magnet slot and the first hole.

9. The rotor core according to claim 1, wherein a third hole is formed between two adjacent pairs of magnet slots among the plurality of pairs of magnet slots, and
the third holes are formed more radially outward of the rotor core than a second line segment connecting the other end of the second magnet slot in one of the two pairs of magnet slots and the other end of the first magnet slot in the other of the two pairs of magnet slots.

10. The rotor core according to claim 9, wherein a distance between the third hole and the first magnet slot or the second magnet slot is equal to or greater than half a thickness of a magnet to be inserted into the first magnet slot or the second magnet slot.

11. The rotor core according to claim 9, wherein a distance between a third line segment connecting one end of the second magnet slot in one of the pairs of magnet slots of the two pairs of magnet slots to one end of the first magnet slot of the other pair of magnet slots of the two pairs of magnet slots and the second line segment is equal to or greater than twice a length of the third hole in the radial direction of the rotor core.

12. The rotor core according to claim 9, wherein respective fourth holes are formed radially inward from the third holes, and
each of the third holes and each of the fourth holes are juxtaposed in the radial direction of the rotor core.

13. A rotor, comprising:
the rotor core according to claim 1,
magnets inserted in each of the plurality of pairs of magnet slots, and
a shaft part inserted in the rotor core.

14. An electric motor, comprising:
the rotor according to claim 13, and
a stator arranged around the rotor.
